(19) United States
(12) Patent Application Publication
(10) Pub. No.: US 2026/0201107 A1
(43) Pub. Date: Jul. 16, 2026

(54) POLYURETHANE FOAM-FORMING REACTION MIXTURES, POLYURETHANE FOAMS FORMED THEREFROM, AND METHODS FOR THEIR PRODUCTION AND USE

(71) Applicant: Covestro LLC, Pittsburgs, PA (US)

(72) Inventors: Brandon PARKS, McKees Rocks, PA (US); Steve APRAHAMIAN, McMurray, PA (US); David MANN, McDonald, PA (US)

(21) Appl. No.: 19/134,296

(22) PCT Filed: Nov. 27, 2023
(86) PCT No.: PCT/US2023/081132

§ 371 Date: May 30, 2025

Related U.S. Application Data
(60) Provisional application No. 63/433,045, filed on Dec. 16, 2022.
(60) Provisional application No. 63/484,624, filed on Feb. 13, 2023.

(51) Int. Cl. C08G 18/76; C08G 18/09; C08G 18/18; C08G 18/20; C08G 18/48

(52) U.S. Cl. CPC C08G 18/7664; C08G 18/092; C08G 18/1808; C08G 18/1825; C08G 18/2036; C08G 18/482; C08G 18/4829; C08G 2110/0025; C08G 2110/005; C08G 2115/02

(57) ABSTRACT

Foam-forming reaction mixtures include a polyol blend, a blowing agent composition, a surfactant, a catalyst and a polyisocyanate. The polyol blend includes a saccharide-initiated polyether polyol and an aromatic amine-initiated polyether polyol. The polyol blend contains less than 3% by weight, based on total weight of polyol, of a polyol having a hydroxyl number of 15 to 300 mg/KOH g and a functionality of 1.5 to 4.0. The polyisocyanate contains at least 85% by weight, based on total weight of polyisocyanate, of a polymeric MDI having an NCO content of 29.0% to 32.0% by weight and a viscosity at 25° C. of 300 to 750 mPa·s, wherein the polymeric MDI comprises, based on total weight of the polymeric MDI, 25% to 40% by weight of monomeric MDI.

### FIELD

The present invention relates to foam-forming reaction mixtures, rigid polyurethane (“PUR”) foams formed therefrom, processes for producing such foams and to the use of such foams. As used herein, the term rigid PUR foam or PUR foam encompasses polyurethane foams which also include polyisocyanurate groups.

### BACKGROUND

Rigid PUR foams have excellent thermal and mechanical properties and are produced by reacting polyisocyanates with compounds having at least two hydrogen atoms that are reactive toward isocyanate groups, such as polyols, in the presence of blowing agents and other additives, such as catalysts and surfactants. The foams are used to produce components which insulate against heat and cold, such as refrigeration appliances (among other things) and can be produced either by continuous or discontinuous processes. A discontinuous process is typically used to produce insulated refrigeration appliances.

In the discontinuous process, an important requirement is reducing the demolding time during production. The properties of rigid PUR foams, including demolding time, are often set by modification of the polyol component. High hydroxyl numbers and functionalities of the polyol component typically have a favorable influence on demolding properties, but since they are highly viscous, they can be used only in limited amounts.

Recently, it was discovered that when using polymeric MDI in a very particular viscosity range in combination with a specific polyol component in the correct mixing ratio, it was possible to obtain rigid PUR foams which have equally good flow properties and mechanical data compared to systems using polymeric MDI having a viscosity of not more than about 200 mPa·s (25° C.) that are customarily used or as compared to systems disclosed in the prior art, but display improved demoldability in a discontinuous process.

Nevertheless, it would be desirable to provide foam-forming reaction mixtures, using such polymeric MDI, that can exhibit even further improved demoldability in a discontinuous production process, without detrimentally impacting other important foam properties such as, for example, thermal insulation properties and dimensionally stability.

The inventions described in this specification were made in view of the foregoing.

### SUMMARY

In some respects, this specification relates to foam-forming reaction mixtures. These reaction mixtures comprise: (a) a polyol blend; (b) a blowing agent composition; (c) a catalyst; (d) a surfactant; and (e) a polyisocyanate. The polyol blend comprises (i) a saccharide-initiated polyether polyol having a hydroxyl number of 400 to 600 mg KOH/g and a functionality of 4.0 to 6.0, which is present in an amount of at least 40% by weight, based on total weight of polyol; and (ii) an aromatic amine-initiated polyether polyol having a hydroxyl number of 100 to 550 mg KOH/g and a functionality of 1.5 to 5.0, which is present in an amount of at least 30% by weight, based on total weight of polyol, with the proviso that the polyol blend contains less than 3% by weight, based on total weight of polyol, of a polyol having a hydroxyl number of 15 to 300 mg/KOH g and a functionality of 1.5 to 4.0. The blowing agent composition comprises (i) a physical blowing agent, and (ii) a chemical blowing agent. The polyisocyanate comprises at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219, October 1994, wherein the polymeric MDI comprises, based on total weight of the polymeric MDI, 25% to 40% by weight of monomeric MDI.

In other respects, this specification relates to processes for making a molded rigid foam. These processes comprise: (a) depositing a foam-forming reaction mixture into a mold, and (b) allowing the foam-forming reaction mixture to react in the mold to form the mold rigid foam. In these processes, the foam-forming reaction mixture comprises: (1) a polyol blend; (2) a blowing agent composition; (3) a catalyst; (4) a surfactant; and (5) a polyisocyanate. The polyol blend comprises (i) a saccharide-initiated polyether polyol having a hydroxyl number of 400 to 600 mg KOH/g and a functionality of 4.0 to 6.0, which is present in an amount of at least 40% by weight, based on total weight of polyol; and (ii) an aromatic amine-initiated polyether polyol having a hydroxyl number of 100 to 550 mg KOH/g and a functionality of 1.5 to 5.0, which is present in an amount of at least 30% by weight, based on total weight of polyol, with the proviso that the polyol blend contains less than 3% by weight, based on total weight of polyol, of a polyol having a hydroxyl number of 15 to 300 mg/KOH g and a functionality of 1.5 to 4.0. The blowing agent composition comprises (i) a physical blowing agent, and (ii) a chemical blowing agent. The polyisocyanate comprises at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219, October 1994, wherein the polymeric MDI comprises, based on total weight of the polymeric MDI, 25% to 40% by weight of monomeric MDI.

This specification also relates to, among other things, rigid foams produced from such foam-forming reaction mixtures and by such processes, as well as to composite elements comprising such rigid foams, including insulated refrigeration appliances comprising such foams.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132 (a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132 (a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described. In the production of polyurethane foams, the hydroxyl groups react with isocyanate groups, —NCO, that are attached to the isocyanate compound. The term “hydroxyl number” refers to the number of reactive hydroxyl groups available for reaction and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group and may be calculated by dividing the molecular weight of the polyol by its functionality. The equivalent weight of a polyol may also be calculated by dividing 56,100 by the hydroxyl number of the polyol-Equivalent Weight (g/eq)=(56.1×1000)/OH number.

As indicated, certain implementations of the present specification relate to foam-forming reaction mixtures useful in the production of rigid foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers, 1964, page 239.

The rigid foams of this specification are the reaction product of a foam-forming reaction mixture that includes a polyisocyanate. As used herein, the term “polyisocyanate” encompasses diisocyanates, as well as polyisocyanates of greater functionality than 2.0. More specifically, the polyisocyanate comprises polymeric MDI. As used herein, “polymeric MDI” refers to a mixture of the isomers of diphenylmethane diisocyanate (“monomeric MDI” or “mMDI”) and oligomers thereof, i.e., the homologues and isomers of MDI having more than two rings, which have at least three aromatic rings and a functionality of at least three (“oligomeric MDI”). “Polymeric MDI”, as used herein, is to be distinguished from modified isocyanates or isocyanate-terminated prepolymers made from monomeric MIDI and/or polymeric MDI.

The polymeric MDI present in the foam-forming reaction mixtures of this specification has a NCO content of 29.0 to 32.0% by weight, based on the total weight of the polymeric MDI and a viscosity at 25° C. (measured according to EN ISO 3219, October 1994) of 300 to 750 mPa·s, such as 320 to 650 mPa·s, 350 to 550 mPa·s, or in some cases, 350 to 500 mPa·s.

In addition, the polymeric MDI comprises, based on its total weight, 25% to 40% by weight of monomeric MDI. In some implementations, the polymeric MDI comprises 25% to 40% by weight of monomeric MDI and 50% to 75% by weight of oligomeric MDI, based on the total weight of polymeric MDI.

In the foam-forming reaction mixtures of this specification, the polymeric MDI is present in an amount of least 85% by weight, such as at least 90% by weight, at least 95% by weight, or at least 99% by weight, based on total weight of polyisocyanate.

Apart from the polymeric MDI, the foam-forming reaction mixture may include other polyisocyanates, such as any of the aliphatic, cycloaliphatic, and aromatic polyisocyanates known for the production of polyurethanes, such as, for example, tolylene diisocyanate (TDI). In certain implementations, such other polyisocyanates are present in an amount of up to 15% by weight, such as up to 10% by weight, or up to 5% by weight, based on the total weight of polyisocyanate. In other implementations, however, the polyisocyanate consists, apart from industrially unavoidable traces of impurities, entirely of polymeric MDI.

The foam-forming reaction mixtures of this specification comprise a polyol blend. The polyol blend comprises (i) a saccharide-initiated polyether polyol having a hydroxyl number of 400 to 600 mg KOH/g and a functionality of 4.0 to 6.0, which is present in an amount of at least 40% by weight, based on total weight of polyol; and (ii) an aromatic amine-initiated polyether polyol having a hydroxyl number of 100 to 550 mg KOH/g and a functionality of 1.5 to 5.0, which is present in an amount of at least 30% by weight, based on total weight of polyol.

As indicated, the polyol blend comprises a saccharide-initiated polyether polyol. As used herein, “saccharide-initiated polyether polyol” refers to a polyether polyol that is the reaction product of an H-functional starter comprising saccharide, such as sucrose, with alkylene oxide in the presence of a catalyst, such as an alkali metal-containing catalyst. Examples of suitable alkylene oxides include ethylene oxide, propylene oxide, butylene oxide, styrene oxide, epichlorohydrin, or a mixture of any two or more thereof. Some examples of suitable saccharide initiators are sucrose, sorbitol, maltitol, etc. as well as other mono-saccharides, di-saccharides, tri-saccharides and polysaccharides. Other initiator compounds are often used in combination with the saccharide initiator to prepare the saccharide-initiated polyether polyol. Saccharides can be co-initiated with for example, compounds such as water, propylene glycol, glycerin, ethylene glycol, ethanol amines, diethylene glycol, or a mixture of any two or more thereof. As will be appreciated, it is possible to use a wide variety of individual initiator compounds in combination with saccharide initiator.

In some implementations, saccharide is the predominant H-functional starter used to produce the saccharide-initiated polyether polyol. This means that, in these implementations, saccharide is present in an amount of more than 50% by weight, such as at least 70% by weight or at least 80% by weight, based on the total weight of H-functional starter used to produce the saccharide-initiated polyether polyol.

In some implementations, propylene oxide is the primary or essentially sole alkylene oxide used to prepare the saccharide-initiated polyether polyol. This means that, in these implementations, propylene oxide is used in an amount of more than 50% by weight, such as at least 60% by weight, at least 70% by weight, at least 80% by weight, at least 90% by weight, or 100% by weight, based on the total weight of alkylene oxide used to prepare the saccharide-initiated polyether polyol. In some implementations, ethylene oxide is employed in a relatively small amount. Thus, in these implementations, ethylene oxide is present in an amount of no more than 50% by weight, such as no more than 40% by weight, or, in some cases, no more than 30% by weight, based on the total weight of alkylene oxide used to prepare that saccharide-initiated polyether polyol.

In some implementations, the saccharide-initiated polyether polyol has an OH number of 400 to 600 mg KOH/g, such as 400 to 500 mg KOH/g, or, in some cases, 450 to 500 mg KOH/g, and a functionality of 4.0 to 6.0, such as 4.8 to 5.6, 5.0 to 5.4, or 5.1 to 5.3. In addition, in some implementations, the saccharide-initiated polyether polyol has a content of —C₂H₄O— units of less than 50% by weight, such as less than 40% by weight, or no more than 30% by weight, based on total weight of the saccharide-initiated polyether polyol.

In the foam-forming reaction mixtures of this specification, the saccharide-initiated polyether polyol is present in an amount of at least 40% by weight, based on the total weight of polyol that is present. More specifically, in some implementations, the saccharide-initiated polyol is present in an amount of 40 to 60% by weight, such as 40 to 50% by weight, based on the total weight of polyol that is present.

The foam-forming reaction mixtures of this specification also comprise an aromatic amine-initiated polyether polyol. As used herein, “aromatic amine-initiated polyether polyol” refers to a polyether polyol that is the reaction product of an H-functional starter comprising an aromatic amine, such as toluenediamine (“TDA”), and alkylene oxide. Such aromatic amine-initiated polyether polyols have a functionality of 1.5 to 5.0, such as 2.0 to 5.0, 3.0 to 4.5, 3.5 to 4.5, 3.8 to 4.2, or 3.8 to 4.0, and a hydroxyl number of 100 to 550 mg KOH/g, such as 300 to 500 mg KOH/g, 350 to 450 mg KOH/g, or 380 to 420 mg KOH/g. In some embodiments, the aromatic amine-initiated polyether polyol has a viscosity at 25° C. of at least 5000 mPas, such as 5000 to 50,000 mPas, 5000 to 30,000 mPas, 10,000 to 30,000 mPas or 20,000 to 30,000 mPas. In some implementations, the aromatic amine-initiated polyether polyol has a free aromatic amine content of no more than 1500 ppm, in some cases no more than 1000 ppm, as measured by GC-FID using a RXT-200 column.

In some implementations, the aromatic amine-initiated polyether polyol comprises the alkoxylation reaction product of a polyol starter consisting essentially of an aromatic diamine with an alkylene oxide consisting essentially of propylene oxide. More specifically, in some implementations, the aromatic diamine starter is used in an amount of at least 95% by weight, at least 98% by weight or, in yet other cases, at least 99% by weight, based on the total weight of polyol starter used to produce the polyether polyol.

Suitable aromatic diamine starters can be monomeric or polymeric and can have primary amine and/or secondary amine functional groups. For example, a primary amine, R—NH₂ reacts with epoxides to give two hydroxyl groups. For example, RNH₂ can react with 2 moles of propylene oxide to yield HO—CH₂CH₂CH₂—NR—CH₂CH₂CH₂—OH. Therefore, an amine functionality of 1 in this case gives a polyol functionality of 2 and a diamine with 2 primary amine groups gives a polyol functionality of 4. Examples of suitable aromatic amines include, but are not limited to, crude toluene diamine obtained by the nitration of toluene followed by reduction, 2,3-toluene diamine, 3,4-toluene diamine, 2,4-toluene diamine, and 2,6-toluene diamine or mixtures thereof, 4,4′-methylene dianiline, methylene-bridged polyphenyl polyamines composed of isomers of methylene dianilines and triamines, and or polyamines of higher molecular weight prepared by reacting aniline with formaldehyde, as well as mixtures of any two or more of the foregoing.

If desired, in addition to the aromatic diamine starter, a relatively small amount of other H-functional starters may be used. In some implementations, one or more additional hydroxyl and/or amine functional starters is employed. In some implementations, for example, such additional starter(s) may comprise trimethylolethane, trimethylolpropane, glycerol, pentaerythritol, 4,4′-dihydroxydiphenyl-propane, sorbitol, sucrose, ethylenediamine, monoethanolamine, diethanolamine, methyl amine, ethylene diamine, diethylene triamine, triethylene tetramine, triethanolamine, ethylene glycol, 1,2- or 1,3-propanediol, 1,2-, 1,3- or 1,4-butanediol, 1,5-heptanediol, 1,6-hexanediol, 1,4-cyclohexanedimethanol, 1,4-cyclohexanedimethanol, 1,3-cyclohexanedimethanol, 1,2-cyclohexanedimethanol, tricyclodecanedimethanol, adamantanediol, pentacyclopentadecanedimethanol, glycerin, pentaerythritol, 4,4′-dihydroxy-diphenylpropane, ammonia, aniline, ethanolamine, triethanolamine, and ethylene diamine, or a mixture of any two or more of the foregoing. Oligomeric and/or polymeric polyols, such as polyether polyols, are also suitable starters, as are Mannich reaction products of phenol or substituted phenols with alkanol amines and formaldehyde or paraformaldehyde.

In some implementations, the propylene oxide is used in an amount of at least 95% by weight, or, in yet other cases, at least 99% by weight, based on the total weight of alkylene oxide used to produce the polyether polyol.

Thus, if desired, in addition to propylene oxide, minor amounts of other alkylene oxides may be used. Such other alkylene oxides may include, for example, ethylene oxide, butylene oxide, or styrene oxide, or a mixture of any two or more thereof. If more than one alkylene oxide, is used, they can be used sequentially or simultaneously.

The aromatic amine-initiated polyol may be prepared by any of a variety of processes. In some implementations, however, the aromatic amine-initiated polyether polyol is produced by a process comprising a first alkoxylation step (“PO1”) comprising reacting an alkylene oxide consisting essentially of propylene oxide with a starter consisting essentially of aromatic diamine at a molar ratio of propylene oxide to aromatic diamine of 1.4:1 to 2.0:1 to form an alkoxylated product. Thus, in carrying out the first alkoxylation step, one mole of aromatic diamine, such as one or more isomers of toluene diamine, is reacted with from 1.4 to 2.0, 1.4 to 1.8 or, in some cases, 1.5 to 1.8 moles of propylene oxide. The reaction between propylene oxide and the aromatic diamine is carried out at a temperature in the range of, for example, 90° C. to 180° C., such as 120° C. to 150° C., or, in some cases 120° C. to 130° C., at atmospheric pressure or moderately elevated pressure. Of course, lower temperatures could be used, but the reaction time would be extended. The alkylene oxide is often added, either continuously or intermittently, at such a rate that the reaction temperature and pressure can be maintained at the desired levels.

The first alkoxylation step is typically conducted in the substantial or complete absence of any added catalyst.

Although a reaction diluent is usually not necessary in carrying out the above alkoxylation, an inert liquid diluent can be present in the reaction mixture, if desired, to aid in the dispersion of the alkylene oxide in the amine mixture. Examples of suitable diluents include monochlorobenzene, N,N-dimethylformamide, toluene, xylene, and the like.

The reaction product resulting from the first alkoxylation step can be purified, if desired, but is often employed, without further treatment, in a second alkoxylation step. If purification of the alkoxylated reaction product is desired before use of the product in the second alkoxylation, the purification can be effected using known procedures. For example, an excess of alkylene oxide, if present, can be removed by entrainment in a stream of inert gas such as nitrogen, argon, or xenon; if an inert organic solvent has been employed as reaction solvent, this can be removed by distillation under reduced pressure and the residue from such treatment or treatments can be purified by chromatography, countercurrent distillation and the like.

In this implementation of the process for producing the aromatic amine-initiated polyether polyol, the alkoxylated product from the first alkoxylation step described above is reacted, in a second alkoxylation step (“PO2”), with an alkylene oxide consisting essentially of propylene oxide, in the presence of an added catalyst, until the ratio of the total moles of propylene oxide added in the process to the moles of aromatic diamine added in the process is 4:1 to 9:1, such as 6:1 to 8:1 or 6:1 to 7:1, and until a polyether polyol having the desired hydroxyl number is obtained. In some implementation, the second alkoxylation step is carried out at a temperature of 90° C. to 180° C., such as 120° C. to 150° C., at atmospheric pressure or moderately elevated pressure in the presence of the added catalyst. Lower reaction temperature could be employed with an increase in reaction times.

As indicated, the PO2 step may be conducted in the presence of added catalyst. Examples of suitable catalysts are tertiary amines, such as pyridine and triethylamine, alkali metals, such as sodium, potassium, and lithium, and alkali metal hydroxides, such as sodium hydroxide, potassium hydroxide, and lithium hydroxide. The amount of added alkoxylation catalyst employed may, for example, be 0.0001 to 1, such as 0.01 to 0.5, part by weight of catalyst per 100 parts by weight of polyether polyol produced.

In some implementations of this process for producing an aromatic amine-initiated polyether polyol, PO2 is at least partially carried out at a temperature higher than PO1. For example, in some implementations, PO2 is at least partially conducted at a temperature that is at least 20° C. higher than PO1, such as at least 30° C. higher than PO1. More specifically, in some implementations, PO2 is conducted initially (such as during or throughout propylene oxide addition) at or near the temperature of PO1 (such as within 20° C., within 10° C. or within 5° C. as PO1) and then increased during a post-reaction period after PO addition. The temperature during PO2 can be increased during and/or after the alkylene oxide addition of PO2. This temperature increase can enable production of polyether polyols having a desirable viscosity and measured OH number, all at a relatively low cycle time. For example, in some implementations, PO2 (which encompasses an alkylene oxide addition period and subsequent “post-reaction” period to allow the alkylene oxide to react to form the resulting polyether polyol of desired measured OH number) is completed in no more than 6 hours, in some cases, no more than 5 hours or, in some cases, no more than 4 hours.

After PO2, the resultant reaction mixture containing the added alkaline catalyst, such as 0.1% to 1.0% as KOH, may be neutralized. In certain implementations, the reaction mixture is neutralized with a hydroxy-carboxylic acid, though, as will be appreciated, other acids, such as sulfuric acid or phosphoric acid, could be used if desired. Neutralization may be accomplished by mixing the hydroxy-carboxylic acid and reaction mixture at ambient conditions with stirring and need not be exact neutrality (i.e., pH=7.0). The reaction mixture may be maintained at a slight acidity or alkalinity, i.e., at a pH of 5 to 11, such as 6 to 10. The neutralized catalyst may be soluble in the polyether polyol so that the product amine-initiated polyol may be used in polyurethane foam-forming equipment without subsequent treatment and without generating large amounts of solid waste material.

In the foam-forming reaction mixtures of this specification, the aromatic amine-initiated polyether polyol is present in an amount of at least 30% by weight, based on the total weight of polyol that is present. More specifically, in some implementations, the foregoing aromatic amine-initiated polyol is present in an amount of 30 to 80% by weight, such as 30 to 60% by weight, or, in some cases, 40 to 60% by weight or 40 to 50% by weight, based on the total weight of polyol that is present.

If desired, the polyol blend may include additional compounds that contain isocyanate-reactive groups, chain extenders and/or crosslinking agents, and polyether polyols and polyester polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine.

For example, in some implementations, the foam-forming reaction mixture comprises an aliphatic triol-initiated polyether polyol having an OH number of 400 to 600 mg KOH/g, such as 400 to 500 mg KOH/g, 450 to 500 mg KOH/g, or 465 to 475 mg KOH/g and a functionality of from greater than 2 to 4, such as 2.5 to 3.5, or, in some cases, 3.0.

Such polyether polyols can be prepared by reacting suitable aliphatic divalent, trivalent and/or more valent alcohols, (e.g., ethanediol, propanediol-1,2 and propanediol-1,3, diethylene glycol, dipropylene glycol, butanediol-1,4, hexanediol-1,6, and glycerin), provided that at least one trivalent alcohol is used. In some embodiments, the polyvalent alcohol starter comprises or, in some cases, consists of glycerin and the alkylene oxide comprises, or, in some cases, consists of propylene oxide.

In some cases, aliphatic triol-initiated polyether polyol is present in an amount of 1 to 20% by weight, such as 5 to 15% by weight or 10 to 15% by weight, based on the total weight of polyol that is present.

Nevertheless, the foam-forming reaction mixtures of this specification contain less than 3% by weight, such as less than 2% by weight, less than 1% by weight, or less than 0.1% by weight, based on total weight of polyol (such as polyether polyol or polyester polyol), of a polyol having a hydroxyl number of 15 to 300 mg/KOH g and a functionality of 1.5 to 4.0. The substantial elimination of such a polyol is currently believed to be critical to obtaining improved demold properties of the foam-forming reaction mixture, as illustrated by the Examples. It was, however, a surprising discovery that the substantial removal of such polyol from the foam-forming reaction mixture did not result in any significant detrimental impact on the thermal insulation performance and dimensional stability of the resulting foam, as also illustrated by the Examples.

In some implementations, aromatic amine-initiated polyether polyol and saccharide-initiated polyether polyol are present in a weight ratio of at least 0.5:1, such as 0.5:1 to 1.5:1, 0.7:1 to 1.0:1, or 0.8:1 to 0.9.5:1. In certain implementations, aromatic amine-initiated polyether polyol and aliphatic triol-initiated polyether polyol are present in a weight ratio of at least 2:1, such as 2:1 to 4:1, 3:1 to 4:1 or 3:1 to 3.5:1. In certain implementations, saccharide-initiated polyether polyol and aliphatic triol-initiated polyether polyol are present in a weight ratio of at least 2:1, such as 3:1 to 5:1, 3.5:1 to 4.5:1 or 3.8:1 to 4.2:1.

In some embodiments, the polyol blend has a weighted average functionality of from 3 to 5, such as 4.0 to 5.0 or 4.2 to 4.6, and/or a weighted average hydroxyl number of from 300 to 500 mg KOH/g, such as 400 to 500 mg KOH/g, or 400 to 450 mg KOH/g. In some cases, the polyol blend is present in the foam-forming reaction mixture in an amount of at least 70% by weight, such as 70 to 90% by weight or 75 to 85% by weight, based on total weight of the foam-forming reaction mixture except for the weight of the polyisocyanate.

In some implementations, for at least the saccharide-initiated polyether polyol, which may be produced using an alkali metal-containing catalyst, such as an alkali metal hydroxide, the catalyst is neutralized catalyst using, for example, sulfuric acid and/or phosphoric acid, rather than with a hydroxy-carboxylic acid comprising lactic acid. Thus, such a neutralization is conducted in the absence of such a hydroxy-carboxylic acid. Indeed, it was observed that demold properties of the foam-forming reaction mixture could be further improved (without detrimental impact on thermal insulation performance or dimensional stability of the resulting foam) through use of a saccharide-initiated polyether polyol produced using an alkali metal-containing catalyst, such as an alkali metal hydroxide, in which the catalyst is neutralized in the absence of such a hydroxy-carboxylic acid, particularly lactic acid.

Further, in some implementations, the polyol blend does not include any filled polyol. As will be appreciated, a “filled polyol” is a dispersion of polymer particles in a base polyol. Examples of filled polyols, any or all of which are excluded from use in the some implementations of the polyol blends employed in the inventions disclosed herein, are “polymer polyols”, in which the polymer particles comprise a polymer comprising the free radical polymerization reaction product of an ethylenically unsaturated compound, “PIPA polyols”, in which the polymer particles comprise a polyisocyanate polyaddition polymer comprising the reaction product of a polymerizable composition comprising an isocyanate and an alkanolamine, and “PHD polyols” in which the polymer particles comprise a polyhydrazodiconamide comprising the reaction product of a reaction mixture comprising an isocyanate and a diamine and/or a hydrazine.

The foam-forming reaction mixtures of this specification comprise a blowing agent composition.

The blowing agent composition comprises a physical blowing agent. As used herein, “physical blowing agents” refers to compounds which are readily volatile because of their physical properties and do not react with the isocyanate component. Suitable physical blowing agents include, for example, hydrocarbons, such as n-pentane, isopentane, cyclopentane, butane, and isobutane, ethers, such as methylal, halogenated ethers, perfluorinated hydrocarbons having from 1 to 8 carbon atoms, such as perfluorohexane, as well as mixtures of these with one another. The use of (hydro) fluorinated olefins, such as HFO 1233zd(E) (trans-1-chloro-3,3,3-trifluoro-1-propene) or HFO 1336mzz(Z) (cis-1,1,1,4,4,4-hexafluoro-2-butene), or additives such as FA 188 from 3M (1,1,1,2,3,4,5,5,5-nonafluoro-4-(trifluoromethyl) pent-2-ene) is also suitable. In some implementations, the physical blowing agent comprises a pentane isomer or a mixture of various pentane isomers, such as cyclopentane. In some cases, hydrocarbons, such as the various pentane isomers, can be combined with perfluorinated hydrocarbons.

In some implementations, the physical blowing agent, such as cyclopentane, is present in an amount of at least 10% by weight, such as 10 to 15% by weight, based on total weight of the foam-forming reaction mixture except for the weight of the polyisocyanate.

The blowing agent composition also comprises a chemical blowing agent, such as water, which reacts with isocyanate to form carbon dioxide. In some cases, water is utilized in an amount of at least 1.70% by weight, such as 1.70 to 5.0% by weight, 2.0 to 4.0% by weight, 2.0 to 3.0% by weight, or 2.1 to 2.5% by weight, based on total weight of the foam-forming reaction mixture except for the weight of the polyisocyanate.

In some implementations, physical blowing agent and chemical blowing agent are present in a relative ratio, by weight, of at least 4:1, such as 4:1 to 50:1, 4:1 to 20:1, 4:1 to 10:1 or 5:1 to 8:1.

The foam-forming reaction mixtures of this specification also comprise a surfactant. Suitable surfactants include, for example, organosilicon compounds, such as polysiloxane-polyalkyene-block copolymers, such as a polyether-modified polysiloxane. Other possible surfactants include polyethylene glycol ethers of long chain alcohols, tertiary amine or alkanolamine salts of long chain alkyl acid sulfate esters, alkylsulfonic esters, or alkylarylsulfonic acids. In some implementations, surfactant is present in an amount of 0.2 to 5.0% by weight, such as 1 to 3% by weight, based on the total weight of the polyurethane foam-forming composition except for the weight of the polyisocyanate.

In some cases, the surfactant comprises a polyether-modified polysiloxane having a hydroxyl number of at least 40 mg KOH/g, such as 40 to 150 mg KOH/g or 40 to 130 mg KOH/g.

The foam-forming reaction mixtures of this specification also include a catalyst, such as amine catalysts and trimerization catalysts. In some cases, amine catalyst is present in an amount of 0.05 to 4% by weight and the salt used as a trimerization catalyst is employed in an amount of 0.1 to 5% by weight, in each case based on total weight of the foam-forming reaction mixture except for the weight of the polyisocyanate.

Specific examples of suitable catalysts include, without limitation, triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris(dimethylaminopropyl) hexahydrotriazine, tris(dimethylaminopropyl)amine, tris(dimethylaminomethyl) phenol, dimethylamino-propylformamide, N,N,N′,N′-tetramethylethylenediamine, N,N,N′,N′-tetramethylbutane-diamine, tetramethylhexanediamine, pentamethyldiethylenetriamine, pentamethyl-dipropylenetriamine, bis(dimethylaminoethyl) ether, dimethylpiperazine, 1,2 dimethyl-imidazole, 1-azabicyclo[3.3.0]octane, bis(dimethylaminopropyl) urea, N methylmorpholine, N-ethylmorpholine, sodium N-[(2-hydroxy-5-nonylphenyl)methyl]-N-methylaminoacetate, N-cyclohexylmorpholine, 2,3-dimethyl-3,4,5,6-tetrahydropyrimidine, triethanolamine, diethanolamine, triisopropanolamine, N-methyldiethanolamine, N ethyldiethanolamine, dimethylethanolamine, bis[2-(N,N-dimethylamino)ethyl] ether, if necessary (if high proportions of polyisocyanurate are wanted) together with at least one catalyst selected from the group consisting of tin(II) acetate, tin(II) octoate, tin(II) ethylhexanoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium acetate, sodium octoate, potassium acetate, potassium octoate, sodium hydroxide.

In some implementations, the catalyst comprises one or more of potassium acetate, potassium octoate, pentamethyldiethylenetriamine, N,N′,N″-tris(dimethylaminopropyl) hexahydrotriazine, tris(dimethylaminomethyl) phenol, bis[2-(N,N-dimethylamino)ethyl] ether and N,N-dimethylcyclohexylamine, such as where the catalyst comprises one or more or pentamethyldiethylenetriamine, N,N′,N″-tris(dimethylaminopropyl) hexahydrotriazine and N,N-dimethylcyclohexylamine.

The foam-forming reaction mixture may, if desired, include a flame retardant, such as where flame retardant is present in the polyol component, such as in an amount of up to 10% by weight, based on total weight of the foam-forming reaction mixture except for the weight of the polyisocyanate. Suitable flame retardants include, for example, bromine- and chlorine-containing paraffins or phosphorus compounds, such as esters of orthophosphoric acid and of metaphosphoric acid, which can contain halogen. Examples are triethyl phosphate, diethyl ethanephosphonate, cresyl diphenyl phosphate, dimethyl propanephosphonate and tris(β-chloroisopropyl)phosphate. Flame retardants which are liquid at room temperature are often used. It can be advantageous to combine various flame retardants with one another.

In some implementations, this specification relates to processes for making a molded rigid foam that comprise: (a) depositing a foam-forming reaction mixture as described herein into a mold, and (b) allowing the foam-forming reaction mixture to react in the mold to form the molded rigid foam.

It has been observed that use of the foam-forming reaction mixture described herein can lead, in particular, to good dimensional accuracy (swelling behavior) of the foam during processing combined with overall very good processing properties. The swelling behavior is critical in determining the time after which a shaped body can be removed from the mold (demoldability). The rigid foams of the invention display a good property profile, in particular low thermal conductivity values.

The mold used in the processes of this specification can be a closed or open mold. Here, “open” means that at least two side walls are present. The foam obtained can be taken from the mold or remain in the mold for its final purpose. A mold by means of which one-piece insulations for refrigeration appliances are produced is particularly suitable according to the invention. The mold may be arranged such that the reaction mixture introduced into it can spread over the bottom of the mold.

The foam-forming reaction mixture can, for example, be produced by means of a conventional high-pressure mixing unit and introduced into the mold by means of a discharge tube. The mixing unit can comprise a mixing chamber into which the individual components of the reaction mixture are fed.

An example of a conventional process for producing insulation for refrigeration appliances is filling of the mold in the tub position, with the appliance lying on the rear wall being filled either from the compressor stage or the top region. Another conventional process is the “top flow” process in which the reaction mixture is introduced from the bottom into a mold and can thus spread over the bottom of the mold.

It can be advantageous to introduce the foam-forming reaction mixture into the mold under a variable injection pressure and/or in an amount which changes over time, as is described, for example, in EP 2 844 394 A. It is possible to use either one discharge tube or a plurality of discharge tubes (multipoint injection) per mold. In addition, the filling process and/or foam formation may be conducted under reduced pressure. In such a process, the reaction mixture is introduced into a foam mold, with subatmospheric pressure being generated in the foam mold before, during or after introduction of the reaction mixture.

After foam formation is complete, the mixture is cured and may be removed from the mold.

The process of the invention makes it possible to produce shaped bodies composed of rigid PUR foams discontinuously with a demolding time for the shaped bodies which is shortened compared to the standard process without their mechanical properties, such as dimensional stability, or processing properties, such as the flowability, being impaired.

This specification also relates to composite systems containing the rigid PUR foams described herein and that may be obtained by the above-described process. The composite systems are often bounded by decor layers both on the upper side and on the underside. Possible decor layers are, for example, polymers, wood and paper. Such discontinuously produced PUR composite systems may be used, for example, for industrial insulation of appliances, such as refrigerators, refrigeration chests, refrigerator-freezer combinations and boilers, insulated containers and cold boxes and also pipes. This specification, therefore, also relates to any such an appliance comprising a rigid PUR foam as described herein, with the mold provided being, in some cases, a housing part of the refrigerator, of the freezer or of the refrigerator-freezer combination.

Various aspects of the subject matter described herein are set out in the following numbered clauses:

Clause 1. A foam-forming reaction mixture comprising: (a) a polyol blend comprising (i) a saccharide-initiated polyether polyol having a hydroxyl number of 400 to 600 mg KOH/g and a functionality of 4.0 to 6.0, which is present in an amount of at least 40% by weight, based on total weight of polyol, and (ii) an aromatic amine-initiated polyether polyol having a hydroxyl number of 100 to 550 mg KOH/g and a functionality of 1.5 to 5.0, which is present in an amount of at least 30% by weight, based on total weight of polyol, with the proviso that the polyol blend contains less than 3% by weight, based on total weight of polyol, of a polyol having a hydroxyl number of 15 to 300 mg/KOH g and a functionality of 1.5 to 4.0; (b) a blowing agent composition comprising (i) a physical blowing agent, and (ii) a chemical blowing agent; (c) a catalyst; (d) a surfactant; and (e) a polyisocyanate comprising at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219, October 1994, wherein the polymeric MDI comprises, based on total weight of the polymeric MDI, 25% to 40% by weight of monomeric MDI.

Clause 2. The foam-forming reaction mixture of clause 1, wherein the polymeric MDI has a viscosity at 25° C. (measured according to EN ISO 3219, October 1994) of 320 to 650 mPa·s, 350 to 550 mPa·s, or 350 to 500 mPa·s.

Clause 3. The foam-forming reaction mixture of clause 1 or clause 2, wherein the polymeric MDI comprises 25% to 40% by weight of monomeric MDI and 50% to 75% by weight of oligomeric MDI, based on the total weight of polymeric MDI.

Clause 4. The foam-forming reaction mixture of one of clause 1 to clause 3, wherein the polymeric MDI is present in an amount of least 90% by weight, at least 95% by weight, or at least 99% by weight, based on total weight of polyisocyanate.

Clause 5. The foam-forming reaction mixture of one of clause 1 to clause 4, wherein the saccharide-initiated polyether polyol is a reaction product of an H-functional starter comprising saccharide, such as sucrose and/or sorbitol, with alkylene oxide, wherein saccharide is present in an amount of more than 50% by weight, at least 70% by weight or at least 80% by weight, based on the total weight of H-functional starter used to prepare the saccharide-initiated polyether polyol.

Clause 6. The foam-forming reaction mixture of clause 5, wherein propylene oxide is present in an amount of more than 50% by weight, at least 60% by weight, at least 70% by weight, at least 80% by weight, at least 90% by weight, or 100% by weight, based on the total weight of alkylene oxide used to prepare the saccharide-initiated polyether polyol.

Clause 7. The foam-forming reaction mixture of one of clause 1 to clause 6, with the proviso that the saccharide-initiated polyether polyol comprises a reaction product of the saccharide with an alkylene oxide, wherein the reaction occurs in the presence of an alkali metal-containing catalyst, wherein the catalyst is not neutralized with a hydroxy-carboxylic acid comprising lactic acid.

Clause 8. The foam-forming reaction mixture of one of clause 1 to clause 7, wherein the saccharide-initiated polyether polyol has an OH number of 400 to 500 mg KOH/g or 450 to 500 mg KOH/g, and/or a functionality of 4.8 to 5.6, 5.0 to 5.4, or 5.1 to 5.3.

Clause 9. The foam-forming reaction mixture of one of clause 1 to clause 8, wherein the saccharide-initiated polyol is present in an amount of 40 to 60% by weight, such as 40 to 50% by weight, based on the total weight of polyol that is present.

Clause 10. The foam-forming reaction mixture of one of clause 1 to clause 9, wherein the aromatic amine-initiated polyether polyol has a functionality of 2.0 to 5.0, 3.0 to 4.5, 3.5 to 4.5, 3.8 to 4.2, or 3.8 to 4.0, and/or a hydroxyl number of 300 to 500 mg KOH/g, 350 to 450 mg KOH/g, or 380 to 420 mg KOH/g.

Clause 11. The foam-forming reaction mixture of one of clause 1 to clause 9, wherein the aromatic amine-initiated polyether polyol has a viscosity at 25° C. of at least 5000 mPas, 5000 to 50,000 mPas, 5000 to 30,000 mPas, 10,000 to 30,000 mPas or 20,000 to 30,000 mPas, and/or the aromatic amine-initiated polyether polyol has a free aromatic amine content of no more than 1500 ppm or no more than 1000 ppm, as measured by GC-FID using a RXT-200 column.

Clause 12. The foam-forming reaction mixture of one of clause 1 to clause 11, wherein the aromatic amine-initiated polyether polyol comprises the alkoxylation reaction product of a polyol starter comprising an aromatic diamine with an alkylene oxide comprising propylene oxide wherein the aromatic diamine starter is present in an amount of at least 95% by weight, at least 98% by weight or at least 99% by weight, based on the total weight of polyol starter used to produce the polyether polyol and, in some cases, propylene oxide is present in an amount of at least 95% by weight or at least 99% by weight, based on the total weight of alkylene oxide used to produce the polyether polyol.

Clause 13. The foam-forming reaction mixture of clause 12, wherein the aromatic diamine starter comprises 2,3-toluene diamine, 3,4-toluene diamine, 2,4-toluene diamine, 2,6-toluene diamine, 4,4′-methylene dianiline, a methylene-bridged polyphenyl polyamine composed of isomers of methylene dianilines and triamines, as well as mixtures of any two or more of the foregoing.

Clause 14. The foam-forming reaction mixture of one of clause 1 to clause 13, wherein the aromatic amine-initiated polyether polyol is present in an amount of 30 to 80% by weight, 30 to 60% by weight, 40 to 60% by weight or 40 to 50% by weight, based on the total weight of polyol that is present.

Clause 15. The foam-forming reaction mixture of one of clause 1 to clause 14, wherein the foam-forming reaction mixture comprises an aliphatic triol-initiated polyether polyol having an OH number of 400 to 600 mg KOH/g, 400 to 500 mg KOH/g, 450 to 500 mg KOH/g, or 465 to 475 mg KOH/g and a functionality of greater than 2 to 4, 2.5 to 3.5, or, in some cases, 3.0.

Clause 16. The foam-forming reaction mixture of clause 15, wherein the aliphatic triol-initiated polyether polyol comprises an alkoxylation reaction product of an aliphatic triol comprising, or consisting of, glycerin and an alkylene oxide comprising, or consisting of, propylene oxide.

Clause 17. The foam-forming reaction mixture of clause 15 or clause 16, wherein the aliphatic triol-initiated polyether polyol is present in an amount of 1 to 20% by weight, 5 to 15% by weight, or 10 to 15% by weight, based on the total weight of polyol that is present.

Clause 18. The foam-forming reaction mixture of one of clause 1 to clause 17, wherein the foam-forming reaction mixture comprises less than 2% by weight, less than 1% by weight, or less than 0.1% by weight, based on total weight of polyol, of a polyol having a hydroxyl number of 15 to 300 mg/KOH g and a functionality of 1.5 to 4.0.

Clause 19. The foam-forming reaction mixture of one of clause 1 to clause 18, wherein the aromatic amine-initiated polyether polyol and the saccharide-initiated polyether polyol are present in a weight ratio of at least 0.5:1, 0.5:1 to 1.5:1, 0.7:1 to 1.0:1 or 0.8:1 to 0.95:1.

Clause 20. The foam-forming reaction mixture of one of clause 15 to clause 19, wherein the aromatic amine-initiated polyether polyol and the aliphatic triol-initiated polyether polyol are present in a weight ratio of at least 2:1, 2:1 to 4:1, 3:1 to 4:1 or 3:1 to 3.5:1 and/or the saccharide-initiated polyether polyol and the aliphatic triol-initiated polyether polyol are present in a weight ratio of at least 2:1, 3:1 to 5:1, 3.5:1 to 4.5:1 or 3.8:1 to 4.2:1.

Clause 21. The foam-forming reaction mixture of one of clause 1 to clause 20, wherein the polyol blend has a weighted average functionality of 3 to 5, 4.0 to 5.0 or 4.2 to 4.6, and/or a weighted average hydroxyl number of 300 to 500 mg KOH/g, 400 to 500 mg KOH/g, or 400 to 450 mg KOH/g.

Clause 22. The foam-forming reaction mixture of one of clause 1 to clause 21, wherein the polyol blend is present in the foam-forming reaction mixture in an amount of at least 70% by weight, 70 to 90% by weight or 75 to 85% by weight, based on the total weight of the foam-forming reaction mixture except for the weight of the polyisocyanate.

Clause 23. The foam-forming reaction mixture of one of clause 1 to clause 22, wherein the polyol blend does not include any filled polyol.

Clause 24. The foam-forming reaction mixture of one of clause 1 to clause 23, wherein the physical blowing agent comprises a hydrocarbon, such as n-pentane, isopentane, cyclopentane, butane, and isobutane.

Clause 25. The foam-forming reaction mixture of one of clause 1 to clause 24, wherein the physical blowing agent, such as cyclopentane, is present in an amount of at least 10% by weight or 10 to 15% by weight, based on the total weight of the foam-forming reaction mixture except for the weight of the polyisocyanate.

Clause 26. The foam-forming reaction mixture of one of clause 1 to clause 25, wherein the chemical blowing agent comprises water present in an amount of at least 1.70% by weight, 1.70 to 5.0% by weight, 2.0 to 4.0% by weight, 2.0 to 3.0% by weight, or 2.1 to 2.5% by weight, based on the total weight of the foam-forming reaction mixture except for the weight of the polyisocyanate.

Clause 27. The foam-forming reaction mixture of one of clause 1 to clause 26, wherein the physical blowing agent and chemical blowing agent are present in a relative ratio, by weight, of at least 4:1, 4:1 to 50:1, 4:1 to 20:1, 4:1 to 10:1 or 5:1 to 8:1.

Clause 28. The foam-forming reaction mixture of one of clause 1 to clause 27, wherein the surfactant comprises a polyether-modified polysiloxane having a hydroxyl number of at least 40 mg KOH/g, 40 to 150 mg KOH/g or 40 to 130 mg KOH/g that is present in an amount of 0.2 to 5.0% by weight or 1 to 3% by weight, based on the total weight of the polyurethane foam-forming composition except for the weight of the polyisocyanate.

Clause 29. The foam-forming reaction mixture of one of clause 1 to clause 28, wherein the catalyst comprises an amine catalyst in an amount of 0.05 to 4% by weight and a trimerization catalyst in an amount of 0.1 to 5% by weight, each based on total weight of the foam-forming reaction mixture except for the weight of the polyisocyanate.

Clause 30. The foam-forming reaction mixture of one of clause 1 to clause 29, wherein the catalyst comprises one or more of potassium acetate, potassium octoate, pentamethyldiethylenetriamine, N,N′,N″-tris(dimethylaminopropyl) hexahydrotriazine, tris(dimethylaminomethyl) phenol, bis[2-(N,N-dimethylamino)ethyl] ether and N,N-dimethylcyclohexylamine, such as where the catalyst comprises one or more or pentamethyldiethylenetriamine, N,N′,N″-tris(dimethylaminopropyl) hexahydrotriazine and N,N-dimethylcyclohexylamine.

Clause 31. A process for making a molded rigid foam comprising: (a) depositing a foam-forming reaction mixture into a mold, and (b) allowing the foam-forming reaction mixture to react in the mold to form the mold rigid foam, wherein the foam-forming reaction mixture comprises: (1) a polyol blend comprising (i) a saccharide-initiated polyether polyol having a hydroxyl number of 400 to 600 mg KOH/g and a functionality of 4.0 to 6.0, which is present in an amount of at least 40% by weight, based on total weight of polyol, and (ii) an aromatic amine-initiated polyether polyol having a hydroxyl number of 100 to 550 mg KOH/g and a functionality of 1.5 to 5.0, which is present in an amount of at least 30% by weight, based on total weight of polyol, with the proviso that the polyol blend contains less than 3% by weight, based on total weight of polyol, of a polyol having a hydroxyl number of 15 to 300 mg/KOH g and a functionality of 1.5 to 4.0; (2) a blowing agent composition comprising (i) a physical blowing agent, and (ii) a chemical blowing agent; (3) a catalyst; (4) a surfactant; and (5) a polyisocyanate comprising at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219 October 1994, wherein the polymeric MDI comprises, based on total weight of the polymeric MDI, 25% to 40% by weight of monomeric MDI.

Clause 32. The process of clause 31, wherein the polymeric MDI has a viscosity at 25° C. (measured according to EN ISO 3219, October 1994) of 320 to 650 mPa·s, 350 to 550 mPa·s, or 350 to 500 mPa·s.

Clause 33. The process of clause 31 or clause 32, wherein the polymeric MDI comprises 25% to 40% by weight of monomeric MDI and 50% to 75% by weight of oligomeric MDI, based on the total weight of polymeric MDI.

Clause 34. The process of one of clause 31 to clause 33, wherein the polymeric MDI is present in an amount of least 90% by weight, at least 95% by weight, or at least 99% by weight, based on total weight of polyisocyanate.

Clause 35. The process of one of clause 31 to clause 34, wherein the saccharide-initiated polyether polyol is a reaction product of an H-functional starter comprising saccharide, such as sucrose and/or sorbitol, with alkylene oxide, wherein saccharide is present in an amount of more than 50% by weight, at least 70% by weight or at least 80% by weight, based on the total weight of H-functional starter used to prepare the saccharide-initiated polyether polyol.

Clause 36. The process of clause 35, wherein propylene oxide is present in an amount of more than 50% by weight, at least 60% by weight, at least 70% by weight, at least 80% by weight, at least 90% by weight, or 100% by weight, based on the total weight of alkylene oxide used to prepare the saccharide-initiated polyether polyol.

Clause 37. The process of one of clause 31 to clause 36, with the proviso that the saccharide-initiated polyether polyol comprises a reaction product of the saccharide with an alkylene oxide, wherein the reaction occurs in the presence of an alkali metal-containing catalyst, wherein the catalyst is not neutralized with a hydroxy-carboxylic acid comprising lactic acid.

Clause 38. The process of one of clause 31 to clause 37, wherein the saccharide-initiated polyether polyol has an OH number of 400 to 500 mg KOH/g or 450 to 500 mg KOH/g, and/or a functionality of 4.8 to 5.6, 5.0 to 5.4, or 5.1 to 5.3.

Clause 39. The process of one of clause 31 to clause 38, wherein the saccharide-initiated polyol is present in an amount of 40 to 60% by weight, such as 40 to 50% by weight, based on the total weight of polyol that is present.

Clause 40. The process of one of clause 31 to clause 39, wherein the aromatic amine-initiated polyether polyol has a functionality of 2.0 to 5.0, 3.0 to 4.5, 3.5 to 4.5, 3.8 to 4.2, or 3.8 to 4.0, and/or a hydroxyl number of 300 to 500 mg KOH/g, 350 to 450 mg KOH/g, or 380 to 420 mg KOH/g.

Clause 41. The process of one of clause 31 to clause 40, wherein the aromatic amine-initiated polyether polyol has a viscosity at 25° C. of at least 5000 mPas, 5000 to 50,000 mPas, 5000 to 30,000 mPas, 10,000 to 30,000 mPas or 20,000 to 30,000 mPas, and/or the process of one of clause 31 to clause 40, wherein the aromatic amine-initiated polyether polyol has a free aromatic amine content of no more than 1500 ppm or no more than 1000 ppm, as measured by GC-FID using a RXT-200 column.

Clause 42. The process of one of clause 31 to clause 41, wherein the aromatic amine-initiated polyether polyol comprises the alkoxylation reaction product of a polyol starter comprising an aromatic diamine with an alkylene oxide comprising propylene oxide wherein the aromatic diamine starter is present in an amount of at least 95% by weight, at least 98% by weight or at least 99% by weight, based on the total weight of polyol starter used to produce the polyether polyol and, in some cases, propylene oxide is present in an amount of at least 95% by weight or at least 99% by weight, based on the total weight of alkylene oxide used to produce the polyether polyol.

Clause 43. The process of clause 42, wherein the aromatic diamine starter comprises 2,3-toluene diamine, 3,4-toluene diamine, 2,4-toluene diamine, 2,6-toluene diamine, 4,4′-methylene dianiline, a methylene-bridged polyphenyl polyamine composed of isomers of methylene dianilines and triamines, as well as mixtures of any two or more of the foregoing.

Clause 44. The process of one of clause 31 to clause 43, wherein the aromatic amine-initiated polyether polyol is present in an amount of 30 to 80% by weight, 30 to 60% by weight, 40 to 60% by weight or 40 to 50% by weight, based on the total weight of polyol that is present.

Clause 45. The process of one of clause 31 to clause 44, wherein the foam-forming reaction mixture comprises an aliphatic triol-initiated polyether polyol having an OH number of 400 to 600 mg KOH/g, 400 to 500 mg KOH/g, 450 to 500 mg KOH/g, or 465 to 475 mg KOH/g and a functionality of greater than 2 to 4, 2.5 to 3.5, or, in some cases, 3.0.

Clause 46. The process of clause 45, wherein the aliphatic triol-initiated polyether polyol comprises an alkoxylation reaction product of an aliphatic triol comprising, or consisting of, glycerin and an alkylene oxide comprising, or consisting of, propylene oxide.

Clause 47. The process of clause 45 or clause 46, wherein the aliphatic triol-initiated polyether polyol is present in an amount of 1 to 20% by weight, 5 to 15% by weight, or 10 to 15% by weight, based on the total weight of polyol that is present.

Clause 48. The process of one of clause 31 to clause 47, wherein the foam-forming reaction mixture comprises less than 2% by weight, less than 1% by weight, or less than 0.1% by weight, based on total weight of polyol, of a polyol having a hydroxyl number of 15 to 300 mg/KOH g and a functionality of 1.5 to 4.0.

Clause 49. The process of one of clause 31 to clause 48, wherein the aromatic amine-initiated polyether polyol and the saccharide-initiated polyether polyol are present in a weight ratio of at least 0.5:1, 0.5:1 to 1.5:1, 0.7:1 to 1.0:1 or 0.8:1 to 0.9.5:1.

Clause 50. The process of one of clause 45 to clause 49, wherein the aromatic amine-initiated polyether polyol and the aliphatic triol-initiated polyether polyol are present in a weight ratio of at least 2:1, 2:1 to 4:1, 3:1 to 4:1 or 3:1 to 3.5:1 and/or the saccharide-initiated polyether polyol and the aliphatic triol-initiated polyether polyol are present in a weight ratio of at least 2:1, 3:1 to 5:1, 3.5:1 to 4.5:1 or 3.8:1 to 4.2:1.

Clause 51. The process of one of clause 31 to clause 50, wherein the polyol blend has a weighted average functionality of 3 to 5, 4.0 to 5.0 or 4.2 to 4.6, and/or a weighted average hydroxyl number of 300 to 500 mg KOH/g, 400 to 500 mg KOH/g, or 400 to 450 mg KOH/g.

Clause 52. The process of one of clause 31 to clause 51, wherein the polyol blend is present in the foam-forming reaction mixture in an amount of at least 70% by weight, 70 to 90% by weight or 75 to 85% by weight, based on the total weight of the foam-forming reaction mixture except for the weight of the polyisocyanate.

Clause 53. The process of one of clause 31 to clause 52, wherein the polyol blend does not include any filled polyol.

Clause 54. The process of one of clause 31 to clause 53, wherein the physical blowing agent comprises a hydrocarbon, such as n-pentane, isopentane, cyclopentane, butane, and isobutane.

Clause 55. The process of one of clause 31 to clause 54, wherein the physical blowing agent, such as cyclopentane, is present in an amount of at least 10% by weight or 10 to 15% by weight, based on the total weight of the foam-forming reaction mixture except for the weight of the polyisocyanate.

Clause 56. The process of one of clause 31 to clause 55, wherein the chemical blowing agent comprises water present in an amount of at least 1.70% by weight, 1.70 to 5.0% by weight, 2.0 to 4.0% by weight, 2.0 to 3.0% by weight, or 2.1 to 2.5% by weight, based on the total weight of the foam-forming reaction mixture except for the weight of the polyisocyanate.

Clause 57. The process of one of clause 31 to clause 56, wherein the physical blowing agent and chemical blowing agent are present in a relative ratio, by weight, of at least 4:1, 4:1 to 50:1, 4:1 to 20:1, 4:1 to 10:1 or 5:1 to 8:1.

Clause 58. The process of one of clause 31 to clause 57, wherein the surfactant comprises a polyether-modified polysiloxane having a hydroxyl number of at least 40 mg KOH/g, 40 to 150 mg KOH/g or 40 to 130 mg KOH/g that is present in an amount of 0.2 to 5.0% by weight or 1 to 3% by weight, based on the total weight of the polyurethane foam-forming composition except for the weight of the polyisocyanate.

Clause 59. The process of one of clause 31 to clause 58, wherein the catalyst comprises an amine catalyst in an amount of 0.05 to 4% by weight and a trimerization catalyst in an amount of 0.1 to 5% by weight, each based on total weight of the foam-forming reaction mixture except for the weight of the polyisocyanate.

Clause 60. The process of one of clause 31 to clause 59, wherein the catalyst comprises one or more of potassium acetate, potassium octoate, pentamethyldiethylenetriamine, N,N′,N″-tris(dimethylaminopropyl)hexahydrotriazine, tris(dimethylaminomethyl) phenol, bis[2-(N,N-dimethylamino)ethyl] ether and N,N-dimethylcyclohexylamine, such as where the catalyst comprises one or more or pentamethyldiethylenetriamine, N,N′,N″-tris(dimethylaminopropyl) hexahydrotriazine and N,N-dimethylcyclohexylamine.

Clause 61. The process of one of clause 31 to clause 60, wherein the foam-forming reaction mixture is introduced into the mold under a variable injection pressure and/or in an amount which changes over time and/or under reduced pressure.

Clause 62. A composite comprising a rigid PUR foam produced from the foam-forming mixture of one of clause 1 to clause 30 or by the process of one of clause 31 to clause 61.

Clause 63. A refrigerator, refrigeration chest, refrigerator-freezer combination, boilers, insulated container, cold box, or pipe comprising a rigid PUR foam produced from the foam-forming mixture of one of clause 1 to clause 30 or by the process of one of clause 31 to clause 61.

The non-limiting and non-exhaustive examples that follow are intended to further describe various non-limiting and non-exhaustive implementations without restricting the scope of the implementations described in this specification.

### EXAMPLES

### Examples 1-10

Foam-forming compositions were prepared using the ingredients and amounts (in parts by weight) set forth in Table 1. The following materials were used:
POLYOL 1: a polyether polyol having a hydroxyl number of 470 mg KOH/g and a functionality of 4.7, prepared by alkoxylating a mixture of sucrose and glycerin in the presence of an alkali metal catalyst, in which the alkylene oxide is 100% propylene oxide and in which the alkali metal catalyst is neutralized with lactic acid;
POLYOL 2: a polyether polyol having a hydroxyl number of 470 mg KOH/g and a functionality of 5.2, prepared by alkoxylating a mixture of sucrose, propylene glycol and water in the presence of an alkali metal catalyst, in which the alkylene oxide is 100% propylene oxide and in which the alkali metal catalyst is neutralized with sulfuric acid;
POLYOL 3: a polyether polyol having a hydroxyl number of 400 mg KOH/g and a functionality of 4, prepared by alkoxylating o-TDA in the presence of an alkali metal catalyst, in which the alkylene oxide is 100% propylene oxide and in which the alkali metal catalyst is neutralized with lactic acid;
POLYOL 4: a polyether polyol having a hydroxyl number of 360 mg KOH/g and a functionality of 4, prepared by alkoxylating o-TDA in the presence of an alkali metal catalyst, in which the alkylene oxide is 100% propylene oxide and in which the alkali metal catalyst is neutralized with lactic acid;
POLYOL 5: a polyether polyol having a hydroxyl number of 470 mg KOH/g and a functionality of 3.0, prepared by alkoxylating glycerin in the presence of an alkali metal catalyst, in which the alkylene oxide is 100% propylene oxide and in which the alkali metal catalyst is neutralized with sulfuric acid
POLYOL 6: an aromatic polyester polyol having an OH number of 240 mg KOH/g and a functionality of 2;
SURFACTANT 1: a polyorganosiloxane polyether copolymer believed to have a hydroxyl number of 123 mg KOH/g, available as Tegostab® B-84205 from Evonik;
SURFACTANT 2: a polyorganosiloxane polyether copolymer believed to have a hydroxyl number of 105 mg KOH/g, available as Tegostab® B-8465 from Evonik;
SURFACTANT 3: a polyorganosiloxane polyether copolymer believed to have a hydroxyl number of 110 mg KOH/g, available as Tegostab® B-8499 from Evonik;
SURFACTANT 4: silicone surfactant with a hydroxyl number of 54 mg KOH/g, available as Vorasurf™ DC 5357 from Dow;
SURFACTANT 5: silicone surfactant with a hydroxyl number of 50 mg KOH/g, available as Vorasurf™ RF 5374 from Dow;
SURFACTANT 6: silicone surfactant with a hydroxyl number of 47.5 mg KOH/g, available as Vorasurf™ RF 5358 from Dow;
CATALYST 1: Dimethylcyclohexylamine
CATALYST 2: N,N,N′,N″,N″-pentamethyldiethylenetriamine;
CATALYST 3: N,N′,N″-Dimethylaminopropylhexahydrotriazine;
CATALYST 4: Bis(dimethylaminomethyl) phenol;
PHYSICAL BA: cyclopentane;
ISO 1: a modified polymeric methylenediphenyl diisocyanate prepolymer, viscosity from ≥235 mPas to ≤435 mPas at 25° C., NCO content 29.8-31.2% by weight, Covestro Deutschland AG; and
ISO 2: polymeric MDI containing 35.2% by weight of diphenylmethane 4,4′-diisocyanate (mMDI), viscosity from ≥350 mPas to ≤450 mPas at 25° C., NCO content 30.0-32.0% by weight, Covestro Deutschland AG.

Foams were prepared using a A-100 or HK-1250 high-pressure foam machine. The liquid output was maintained at a constant 27 or 32° C. for the Resin and 27 or 32° C. for the Isocyanate side with an output range of 454 grams/second. Foam was shot into a 79″×8″×2″ (200×20×5 cm) mold between heated platens with a target overpack of 10% based on minimum fill density. The platens were maintained at 49° C. The foam remained in the mold and was allowed to cure for 10 minutes at 49° C. before removing. An 8″×8″×1″ section of foam was sampled from the panels and used for k-factor testing according to ASTM C518. Lid opening swell was determined by foaming the aforementioned mold at an overpack level of 10% and allowing the part to demold for 1.5 or 2 minutes. After 1.5 or 2 minutes, the lid clamps were removed and the lid allowed to open based on the degree of foam swelling. The degree of swelling was measured at 30 seconds, 180 seconds, and 300 seconds after the lid clamps were removed. Jumbo tool demold was determined by foaming a 70 cm×40 cm×9 cm closed mold via a shot port at a mold temperature of 45° C. with an amount of foam to achieve a foam density of either 2.10 or 2.30 pcf. After the foam was dispensed, the shot port was closed with a cork and the foam allowed to cure for the specified amount of time (1.5, 2, 3, or 4 minutes). After the specified demold time, the mold lid was opened and the part removed and allowed to rest overnight. After 24 hours, the thickness of the part was measured at the centermost point to determine the degree of foam swelling.

Results are set forth in Table 1. Examples 9-13 are inventive examples and Examples 1-8 are comparative examples.

TABLE 1

| Ingredient | | 1 | 2 | 3 | 4 | 5 | 6 | 7 |
|---|---|---|---|---|---|---|---|---|
| POLYOL 1 | | 40.48 | 40.48 | 37.84 | 42.20 | 42.02 | 42.85 | 42.60 |
| POLYOL 2 | | — | — | — | — | — | — | — |
| POLYOL 3 | | — | — | 34.95 | 30.07 | 29.94 | 30.53 | 30.35 |
| POLYOL 4 | | 32.38 | 32.38 | — | — | — | — | — |
| POLYOL 5 | | — | — | — | — | — | — | — |
| POLYOL 6 | | 8.09 | 8.09 | 9.93 | 9.86 | 9.82 | 10.01 | 9.96 |
| SURFACTANT 1 | | — | — | — | — | — | — | — |
| SURFACTANT 2 | | 2.48 | 2.48 | — | 2.46 | 2.45 | 2.45 | 2.45 |
| SURFACTANT 3 | | — | — | 2.50 | — | — | — | — |
| SURFACTANT 4 | | — | — | — | — | — | — | — |
| SURFACTANT 5 | | — | — | — | — | — | — | — |
| SURFACTANT 6 | | — | — | — | — | — | — | — |
| CATALYST 1 | | — | — | 0.58 | 0.56 | 0.78 | 0.77 | 0.80 |
| CATALYST 2 | | 1.12 | 1.12 | 0.25 | 0.24 | 0.33 | 0.48 | 0.50 |
| CATALYST 3 | | 0.56 | 0.56 | 0.30 | 0.28 | 0.39 | 0.19 | 0.20 |
| CATALYST 4 | | — | — | — | — | — | — | — |
| Water | | 1.64 | 1.64 | 1.65 | 1.83 | 1.82 | 1.87 | 1.93 |
| PHYSICAL BA | | 13.25 | 13.25 | 12.00 | 12.50 | 12.45 | 10.85 | 11.21 |
| ISOCYANATE | | ISO 1 | ISO 2 | ISO 1 | ISO 2 | ISO 2 | ISO 2 | ISO 2 |
| Index | | 1.34 | 1.38 | 1.10 | 1.11 | 1.11 | 1.20 | 1.20 |
| Ratio | | 140 | 140 | 120 | 123 | 123 | 135 | 136 |
| Resin Temperature (° F.) | | 90 | 90 | 80 | 90 | 90 | 90 | 90 |
| Isocyanate Temperature (° F.) | | 90 | 90 | 80 | 90 | 90 | 90 | 90 |
| Reactivity | Cream (s) | 2 | 2 | Froth | 7 | Froth | 3 | 3 |
| | Gel (s) | 25 | 26 | 41 | 35 | 28 | 32 | 29 |
| | Free-Rise | 1.42 | 1.49 | 1.41 | 1.31 | 1.31 | 1.53 | 1.50 |
| | Density | | | | | | | |
| | (pcf) | | | | | | | |
| Bosch Min. Fill Density (pcf) | | 2.07 | 2.13 | 2.07 | 2.00 | 1.96 | 2.29 | 2.16 |
| Packed Density (10%, pcf) | | 2.28 | 2.35 | 2.29 | 2.20 | 2.17 | 2.53 | 2.37 |
| Core Density (pcf) | | 2.01 | 2.06 | 1.98 | 1.92 | 1.90 | 2.22 | 2.06 |
| Overall vs Core Density Ratio | | 1.13 | 1.14 | 1.16 | 1.15 | 1.14 | 1.14 | 1.15 |
| Closed Cell Content (%) | | 92.3 | 92.8 | 93.0 | 91.1 | 91.5 | 91.8 | 92.2 |
| k-Factor | 35° F. | 0.130 | 0.129 | 0.127 | 0.128 | 0.127 | 0.134 | 0.134 |
| | 75° F. | 0.141 | 0.139 | 0.137 | 0.138 | 0.137 | 0.145 | 0.146 |
| Compressive | + | 23.8 | 26.4 | 21.0 | 21.1 | 20.6 | 28.9 | 25.4 |
| Strength (psi) | = | 37.9 | 42.0 | 38.1 | 36.0 | 36.2 | 45.8 | 44.0 |
| Dimensional | 1 Day @ | 0.0 | 0.0 | 0.3 | −0.1 | 0.1 | −0.2 | −0.1 |
| Stability | −30° C. | | | | | | | |
| | 7 Days @ | 0.1 | 0.0 | 0.1 | −0.2 | −0.3 | −0.3 | −0.2 |
| | −30° C. | | | | | | | |
| | 1 Day @ | −0.5 | −0.5 | −0.2 | −0.3 | 0.6 | −0.8 | −0.5 |
| | 70° C. | | | | | | | |
| | 7 Days @ | 0.2 | −0.1 | 0.5 | 0.0 | 0.6 | −0.3 | −0.5 |
| | 70° C. | | | | | | | |
| Lid Opening @ | 0.5 | — | — | 0.636 | 0.319 | 0.293 | 0.334 | 0.308 |
| 10% Overpack; | 3.0 | — | — | 0.581 | 0.278 | 0.264 | 0.302 | 0.282 |
| 1.5 min Demold | 5.0 | — | — | 0.564 | 0.261 | 0.253 | 0.288 | 0.270 |
| Time (in) | | | | | | | | |
| Lid Opening @ | 0.5 | 0.116 | 0.102 | 0.311 | 0.213 | 0.149 | 0.157 | 0.151 |
| 10% Overpack; 2 | 3.0 | 0.103 | 0.089 | 0.282 | 0.191 | 0.128 | 0.144 | 0.132 |
| min Demold | 5.0 | 0.096 | 0.081 | 0.271 | 0.178 | 0.118 | 0.135 | 0.123 |
| Time (in) | | | | | | | | |
| Jumbo Tool Swell | 1.5 | 7.7 | 5.6 | — | — | — | — | 6.0 |
| @ 2.10 pcf (mm) | 2.0 | 6.2 | 4.5 | — | — | — | — | 3.4 |
| After 24 h | 3.0 | 4.8 | 3.5 | — | — | — | — | 1.8 |
| | 4.0 | 2.8 | 2.1 | — | — | — | — | 1.1 |
| Jumbo Tool Swell | 1.5 | 9.6 | 8.0 | — | — | — | — | 8.2 |
| @ 2.30 pcf (mm) | 2.0 | 8.7 | 6.7 | — | — | — | — | 6.7 |
| After 24 h | 3.0 | 6.7 | 5.2 | — | — | — | — | 4.5 |
| | 4.0 | 4.9 | 3.6 | — | — | — | — | 3.9 |

| Ingredient | | 8 | 9 | 10 | 11 | 12 | 13 |
|---|---|---|---|---|---|---|---|
| POLYOL 1 | | 42.20 | — | — | — | — | — |
| POLYOL 2 | | — | 37.37 | 38.23 | 38.23 | 38.23 | 38.23 |
| POLYOL 3 | | 30.07 | 31.81 | 32.55 | 32.55 | 32.55 | 32.55 |
| POLYOL 4 | | — | — | — | — | — | — |
| POLYOL 5 | | — | 9.34 | 9.56 | 9.56 | 9.56 | 9.56 |
| POLYOL 6 | | 9.87 | — | — | — | — | — |
| SURFACTANT 1 | | — | 2.60 | 2.66 | — | — | — |
| SURFACTANT 2 | | 2.60 | — | — | — | — | — |
| SURFACTANT 3 | | — | — | — | — | — | — |
| SURFACTANT 4 | | — | — | — | 2.66 | — | — |
| SURFACTANT 5 | | — | — | — | — | 2.66 | — |
| SURFACTANT 6 | | — | — | — | — | — | 2.66 |
| CATALYST 1 | | 0.99 | 1.70 | 1.74 | 1.74 | 1.74 | 1.74 |
| CATALYST 2 | | 0.62 | 1.11 | 1.14 | 1.14 | 1.14 | 1.14 |
| CATALYST 3 | | 0.25 | 0.40 | 0.41 | 0.41 | 0.41 | 0.41 |
| CATALYST 4 | | — | 0.48 | 0.49 | 0.49 | 0.49 | 0.49 |
| Water | | 1.97 | 2.15 | 2.2 | 2,2 | 2.2 | 2.2 |
| PHYSICAL BA | | 11.43 | 13.04 | 11.02 | 11.02 | 11.02 | 11.02 |
| ISOCYANATE | | ISO 2 | ISO 2 | ISO 2 | ISO 2 | ISO 2 | ISO 2 |
| Index | | 1.20 | 1.20 | 1.20 | 1.20 | 1.20 | 1.20 |
| Ratio | | 136 | 140 | 142 | 142 | 142 | 142 |
| Resin Temperature (° F.) | | 90 | 90 | 90 | 90 | 90 | 90 |
| Isocyanate Temperature (° F.) | | 90 | 90 | 90 | 90 | 90 | 90 |
| Reactivity | Cream (s) | 3 | 2 | 2 | 2 | 2 | 2 |
| | Gel (s) | 26 | 19 | 18 | 15 | 15 | 15 |
| | Free-Rise | 1.45 | 1.35 | 1.48 | 1.48 | 1.51 | 1.46 |
| | Density (pcf) | | | | | | |
| Bosch Min. Fill Density (pcf) | | 2.16 | 1.97 | 2.00 | 2.00 | 1.98 | 1.97 |
| Packed Density (10%, pcf) | | 2.37 | 2.17 | 2.21 | 2.21 | 2.19 | 2.18 |
| Core Density (pcf) | | 2.03 | 1.92 | 2.01 | 1.92 | 2.04 | 1.99 |
| Overall vs Core Density Ratio | | 1.17 | 1.13 | 1.10 | 1.15 | 1.07 | 1.10 |
| Closed Cell Content (%) | | 92.4 | 91.9 | 90.6 | 90.2 | 91.0 | 91.3 |
| k-Factor | 35° F. | 0.130 | 0.129 | 0.127 | 0.130 | 0.128 | 0.127 |
| | 75° F. | 0.140 | 0.14 | 0.138 | 0.143 | 0.139 | 0.137 |
| Compressive | + | 23.1 | 21.8 | 24.3 | 24.5 | 25.3 | 23.7 |
| Strength (psi) | = | 46.3 | 37.8 | 27.4 | 30.7 | 40.1 | 42.0 |
| Dimensional | 1 Day @ | 0.0 | −0.2 | −0.3 | 0.1 | −0.3 | 0.1 |
| Stability | −30° C. | | | | | | |
| | 7 Days @ | −0.3 | −0.3 | 0.0 | 0.3 | −0.2 | 0.0 |
| | −30° C. | | | | | | |
| | 1 Day @ | −0.6 | −0.6 | −0.7 | −0.6 | −0.6 | −0.6 |
| | 70° C. | | | | | | |
| | 7 Days @ | −0.5 | −0.1 | 0.2 | 0.5 | 0.3 | 0.3 |
| | 70° C. | | | | | | |
| Lid Opening @ | 0.5 | 0.224 | 0.061 | 0.049 | 0.047 | 0.042 | 0.051 |
| 10% Overpack; | 3.0 | 0.197 | 0.050 | 0.035 | 0.032 | 0.026 | 0.037 |
| 1.5 min Demold | 5.0 | 0.186 | 0.043 | 0.029 | 0.025 | 0.022 | 0.030 |
| Time (in) | | | | | | | |
| Lid Opening @ | 0.5 | 0.103 | 0.030 | 0.028 | 0.011 | 0.020 | 0.027 |
| 10% Overpack; | 3.0 | 0.088 | 0.018 | 0.014 | 0.011 | 0.009 | 0.015 |
| 2 min Demold | 5.0 | 0.079 | 0.013 | 0.008 | 0.005 | 0.004 | 0.012 |
| Time (in) | | | | | | | |
| Jumbo Tool | 1.5 | 6.3 | 4.4 | 3.9 | 3.6 | 3.3 | 3.3 |
| Swell @ 2.10 pcf | 2.0 | 5.4 | 3.1 | 3.6 | 3.5 | 2.9 | 2.1 |
| (mm) After 24 h | 3.0 | 3.7 | 2.7 | 2.3 | 1.7 | 1.8 | 2.0 |
| | 4.0 | 2.8 | 1.7 | 1.5 | 1.6 | 1.6 | 1.7 |
| Jumbo Tool | 1.5 | 8.2 | 5.9 | 5.0 | 5.6 | 5.0 | 6.1 |
| Swell @, 2.30 pcf | 2.0 | 7.3 | 4.9 | 4.4 | 4.4 | 4.3 | 5.1 |
| (mm) After 24 h | 3.0 | 5.7 | 3.9 | 3.5 | 3.1 | 3.2 | 3.4 |
| | 4.0 | 4.2 | 3.1 | 2.4 | 2.3 | 2.7 | 3.1 |

### Examples 14-20

Foam-forming compositions were prepared using the ingredients and amounts (in parts by weight) set forth in Table 2. Foam samples were prepared by hand using an air-powered mixer (~3000 rpm) and utilizing a temperature controlled mold (120° F.; dimensions of 25″×13″×2″). The polyol premix and isocyanate temperatures were maintained at 20° C. and all samples were demolded after 3 minutes. Minimum fill was determined by slightly overfilling the mold cavity and then removing the excess foam such that the foam weight contained in the 25″×13″×2″ volume could be measured. After determining the minimum fill value, foam panels were prepared to obtain a desired density approximately 8-12% over the minimum fill density. Lab swell was determined by pouring the foaming mixture into a temperature controlled mold (104° F.; dimensions of 8″×8″×4″) to achieve a desired density approximately 22-27% over the minimum fill density. Minimum fill density for this test method is determined based on the overall foam height (flow) as measured using the method described in U.S. Pat. No. 10,106,641 (at col. 12, lines 22-61). After 5 minutes the sample was demolded and allowed to rest for 30 minutes under ambient conditions. After 30 minutes the thickness of the centermost point of the sample was measured to determine to degree of foam swelling. Examples 15, 17 and 20 are inventive examples and Examples 14, 16, and 18-19 are comparative examples.

TABLE 2

| Ingredient | | 14 | 15 | 16 | 17 | 18 | 19 | 20 |
|---|---|---|---|---|---|---|---|---|
| POLYOL 1 | | — | 46.71 | 42.04 | — | — | — | — |
| POLYOL 2 | | 33.76 | — | — | 46.71 | 42.04 | 33.63 | 37.37 |
| POLYOL 3 | | 30.07 | 31.81 | 28.63 | 31.81 | 28.63 | 28.63 | 31.81 |
| POLYOL 5 | | 8.44 | — | — | — | — | 8.41 | 9.34 |
| POLYOL 6 | | 9.87 | — | 7.85 | — | 7.85 | 7.85 | — |
| SURFACTANT 1 | | — | 2.60 | 2.60 | 2.60 | 2.60 | 2.60 | 2.60 |
| SURFACTANT 2 | | 2.60 | — | — | — | — | — | — |
| SURFACTANT 3 | | — | — | — | — | — | — | — |
| CATALYST 1 | | 0.99 | 1.70 | 1.70 | 1.70 | 1.70 | 1.70 | 1.70 |
| CATALYST 2 | | 0.62 | 1.11 | 1.11 | 1.11 | 1.11 | 1.11 | 1.11 |
| CATALYST 3 | | 0.25 | 0.40 | 0.40 | 0.40 | 0.40 | 0.40 | 0.40 |
| CATALYST 4 | | | 0.48 | 0.48 | 0.48 | 0.48 | 0.48 | 0.48 |
| Water | | 1.97 | 2.15 | 2.15 | 2.15 | 2.15 | 2.15 | 2.15 |
| PHYSICAL BA | | 11.43 | 13.04 | 13.04 | 13.04 | 13.04 | 13.04 | 13.04 |
| Isocyanate | | ISO 2 | ISO 2 | ISO 2 | ISO 2 | ISO 2 | ISO 2 | ISO 2 |
| Index | | 1.20 | 1.20 | 1.24 | 1.20 | 1.24 | 1.24 | 1.20 |
| Ratio | | 136 | 140 | 140 | 140 | 140 | 140 | 140 |
| Resin Temperature (° F.) | | 68 | 68 | 68 | 68 | 68 | 68 | 68 |
| Isocyanate Temperature (° F.) | | 68 | 68 | 68 | 68 | 68 | 68 | 68 |
| Reactivity | Cream (s) | 5 | 3 | 3 | 3 | 3 | 3 | 4 |
| | Gel (s) | 33 | 23 | 21 | 22 | 21 | 21 | 21 |
| | Free-Rise | 1.55 | 1.44 | 1.43 | 1.44 | 1.46 | 1.4 | 1.43 |
| | Density | | | | | | | |
| | (pcf) | | | | | | | |
| Min. Fill Density (pcf) | | — | 1.95 | 1.90 | 1.98 | — | 1.91 | 1.98 |
| Packed Density (10%, pcf) | | — | 2.14 | 2.11 | 2.17 | — | 2.09 | 2.19 |
| Core Density (pcf) | | — | 1.92 | 1.84 | 1.93 | — | 1.98 | 1.84 |
| Overall vs Core Density | | — | 1.11 | 1.15 | 1.12 | — | 1.06 | 1.19 |
| Ratio | | | | | | | | |
| Closed Cell Content (%) | | — | 89.0 | 89.7 | 90.5 | — | 90.0 | 91.1 |
| k-Factor | 35° F. | — | 0.139 | 0.137 | 0.137 | — | 0.131 | 0.134 |
| | 75° F. | — | 0.152 | 0.150 | 0.149 | — | 0.144 | 0.148 |
| Compressive | + | — | 21.4 | 19.6 | 20.4 | — | 21.2 | 22.8 |
| Strength (psi) | = | — | 46.0 | 44.6 | 46.1 | — | 40.1 | 45.8 |
| Dimensional | 1 Day @ | — | −0.1 | −0.3 | 0.0 | | −0.1 | −0.2 |
| Stability | −30° C. | | | | | | | |
| | 7 Days @ | — | −0.2 | −0.4 | 0.0 | — | −0.1 | −0.4 |
| | −30° C. | | | | | | | |
| | 1 Day @ | — | −0.4 | −0.3 | −0.4 | — | −0.4 | −0.6 |
| | 70° C. | | | | | | | |
| | 7 Days @ | — | −0.7 | −0.5 | −0.7 | — | −0.7 | −0.9 |
| | 70° C. | | | | | | | |
| Lab Swell | 2.0 | 0.25 | 0.12 | 0.25 | 0.10 | 0.16 | 0.26 | 0.12 |
| After 30 min | 5.0 | 0.07 | 0.04 | 0.11 | 0.03 | 0.06 | 0.11 | 0.03 |
| (in) | | | | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A foam-forming reaction mixture comprising:
(a) a polyol blend comprising:
(i) a saccharide-initiated polyether polyol having a hydroxyl number of 400 to 600 mg KOH/g and a functionality of 4.0 to 6.0, which is present in an amount of at least 40% by weight, based on total weight of polyol, and
(ii) an aromatic amine-initiated polyether polyol having a hydroxyl number of 100 to 550 mg KOH/g and a functionality of 1.5 to 5.0, which is present in an amount of at least 30% by weight, based on total weight of polyol,
with the proviso that the polyol blend contains less than 3% by weight, based on total weight of polyol, of a polyol having a hydroxyl number of 15 to 300 mg/KOH g and a functionality of 1.5 to 4.0;
(b) a blowing agent composition comprising (i) a physical blowing agent, and (ii) a chemical blowing agent;
(c) a catalyst;
(d) a surfactant; and
(e) a polyisocyanate comprising at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219, October 1994, wherein the polymeric MDI comprises, based on total weight of the polymeric MDI, 25% to 40% by weight of monomeric MDI.

2-63. (canceled)

64. The foam-forming reaction mixture of claim 1, wherein the polymeric MDI has a viscosity at 25° C., measured according to EN ISO 3219, October 1994, of 350 to 500 mPa·s.

65. The foam-forming reaction mixture of claim 1, wherein the polymeric MDI comprises 25% to 40% by weight of monomeric MDI and 50% to 75% by weight of oligomeric MDI, based on the total weight of polymeric MDI.

66. The foam-forming reaction mixture of claim 1, wherein the polymeric MDI is present in an amount of least 90% by weight, based on total weight of polyisocyanate.

67. The foam-forming reaction mixture of claim 1, wherein the saccharide-initiated polyether polyol is a reaction product of an H-functional starter comprising saccharide with alkylene oxide, wherein saccharide is present in an amount of at least 80% by weight, based on the total weight of H-functional starter used to prepare the saccharide-initiated polyether polyol and propylene oxide is present in an amount of at least 90% by weight, based on the total weight of alkylene oxide used to prepare the saccharide-initiated polyether polyol.

68. The foam-forming reaction mixture of claim 1, wherein the saccharide-initiated polyether polyol has an OH number of 400 to 500 mg KOH/g and a functionality of 5.0 to 5.4.

69. The foam-forming reaction mixture of claim 1, wherein the saccharide-initiated polyol is present in an amount of 40 to 60% by weight, based on the total weight of polyol that is present.

70. The foam-forming reaction mixture of claim 1, wherein the aromatic amine-initiated polyether polyol has a functionality of 3.5 to 4.5 and a hydroxyl number of 350 to 450 mg KOH/g.

71. The foam-forming reaction mixture of claim 1, wherein the aromatic amine-initiated polyether polyol comprises an alkoxylation reaction product of a polyol starter comprising an aromatic diamine with an alkylene oxide comprising propylene oxide wherein the aromatic diamine starter is present in an amount of at least 95% by weight, based on the total weight of polyol starter used to produce the aromatic amine-initiated polyether polyol and propylene oxide is present in an amount of at least 95% by weight, based on the total weight of alkylene oxide used to produce the aromatic amine-initiated polyether polyol.

72. The foam-forming reaction mixture of claim 1, wherein the aromatic amine-initiated polyether polyol is present in an amount of 30 to 80% by weight, based on the total weight of polyol that is present.

73. The foam-forming reaction mixture of claim 1, wherein the foam-forming reaction mixture further comprises an aliphatic triol-initiated polyether polyol having an OH number of 400 to 600 mg KOH/g and a functionality of 2.5 to 3.5.

74. The foam-forming reaction mixture of claim 73, wherein the aliphatic triol-initiated polyether polyol is present in an amount of 1 to 20% by weight, based on the total weight of polyol that is present.

75. The foam-forming reaction mixture of claim 1, wherein the foam-forming reaction mixture comprises less than 1% by weight, based on total weight of polyol, of a polyol having a hydroxyl number of 15 to 300 mg/KOH g and a functionality of 1.5 to 4.0.

76. The foam-forming reaction mixture of claim 73, wherein the aromatic amine-initiated polyether polyol and the saccharide-initiated polyether polyol are present in a weight ratio of 0.5:1 to 1.5:1, the aromatic amine-initiated polyether polyol and the aliphatic triol-initiated polyether polyol are present in a weight ratio of 2:1 to 4:1, and the saccharide-initiated polyether polyol and the aliphatic triol-initiated polyether polyol are present in a weight ratio of 3:1 to 5:1.

77. The foam-forming reaction mixture of claim 1, wherein the physical blowing agent comprises cyclopentane in an amount of 10 to 15% by weight, based on the total weight of the foam-forming reaction mixture except for the weight of the polyisocyanate.

78. The foam-forming reaction mixture of claim 77, wherein the chemical blowing agent comprises water present in an amount of 1.70 to 5.0% by weight, based on the total weight of the foam-forming reaction mixture except for the weight of the polyisocyanate.

79. The foam-forming reaction mixture of claim 1, wherein the surfactant comprises a polyether-modified polysiloxane having a hydroxyl number of 40 to 150 mg KOH/g that is present in an amount of 0.2 to 5.0% by weight, based on the total weight of the polyurethane foam-forming composition except for the weight of the polyisocyanate.

80. The foam-forming reaction mixture of claim 1, wherein the catalyst comprises an amine catalyst in an amount of 0.05 to 4% by weight and a trimerization catalyst in an amount of 0.1 to 5% by weight, each based on total weight of the foam-forming reaction mixture except for the weight of the polyisocyanate.

81. A process for making a molded rigid foam comprising:
(a) depositing the foam-forming reaction mixture into a mold, and
(b) allowing the foam-forming reaction mixture to react in the mold to form the mold rigid foam, wherein the foam-forming reaction mixture comprises:
(1) a polyol blend comprising:
(i) a saccharide-initiated polyether polyol having a hydroxyl number of 400 to 600 mg KOH/g and a functionality of 4.0 to 6.0, which is present in an amount of at least 40% by weight, based on total weight of polyol, and
(ii) an aromatic amine-initiated polyether polyol having a hydroxyl number of 100 to 550 mg KOH/g and a functionality of 1.5 to 5.0, which is present in an amount of at least 30% by weight, based on total weight of polyol,
with the proviso that the polyol blend contains less than 3% by weight, based on total weight of polyol, of a polyol having a hydroxyl number of 15 to 300 mg/KOH g and a functionality of 1.5 to 4.0;
(2) a blowing agent composition comprising (i) a physical blowing agent, and (ii) a chemical blowing agent;
(3) a catalyst;
(4) a surfactant; and
(5) a polyisocyanate comprising at least 85% by weight, based on total weight of polyisocyanate, of a polymeric MDI having an NCO content of 29.0% to 32.0% by weight and a viscosity at 25° C. of 300 to 750 mPa·s, measured according to EN ISO 3219, October 1994, wherein the polymeric MDI comprises, based on total weight of the polymeric MDI, 25% to 40% by weight of monomeric MDI.
